(19) United States
(12) Patent Application Publication
(10) Pub. No.: US 2025/0353300 A1
(43) Pub. Date: Nov. 20, 2025

(54) LIQUID EJECTING HEAD AND LIQUID EJECTING APPARATUS

(71) Applicant: SEIKO EPSON CORPORATION, Tokyo (JP)

(72) Inventors: Motoki TAKABE, SHIOJIRI-SHI (JP); Nobuaki ITO, SUWA-SHI (JP)

(21) Appl. No.: 19/207,702

(22) Filed: May 14, 2025

(30) Foreign Application Priority Data
May 16, 2024 (JP) 2024-080153

(51) Int. Cl. B41J 2/14

(52) U.S. Cl. CPC B41J 2/14233; B41J 2002/14258; B41J 2002/14491

(57) ABSTRACT

A liquid ejecting head includes: in which when a region in an arrangement direction where the second thin film piezoelectric body overlaps all of the individual electrode, the first common electrode, and the second common electrode when viewed in the lamination direction is defined as an overlapping region, and a region in the arrangement direction where the second thin film piezoelectric body overlaps the first common electrode and the second common electrode and does not overlap the individual electrode when viewed in the lamination direction is defined as a non-overlapping region, a position of an upper surface of the second thin film piezoelectric body in the overlapping region is a first position, and the position of the upper surface of the second thin film piezoelectric body in the non-overlapping region is a second position that is located lower than the first position.

The present application is based on, and claims priority from JP Application Serial Number 2024-080153, filed May 16, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

A liquid ejecting apparatus including a liquid ejecting head for ejecting liquid such as ink to a medium such as printing paper is proposed in the related art. A piezo-type ink jet printer is known as the liquid ejecting apparatus. In the piezo-type, a piezoelectric element that vibrates a diaphragm that constitutes a part of a wall surface of a pressure chamber is used. The diaphragm is vibrated by the piezoelectric element, and thus the liquid in the pressure chamber is ejected from a nozzle.

In a piezoelectric element provided in a liquid ejecting head disclosed in JP-A-2013-256137, a first common electrode, a lower piezoelectric layer of a thin film, an individual electrode, an upper piezoelectric layer of a thin film, and a second common electrode are laminated in order. That is, the piezoelectric element has a configuration in which two thin film piezoelectric bodies are laminated.

When the thin film piezoelectric bodies are laminated as in JP-A-2013-256137, an amount of displacement per unit voltage can be increased by nearly two times as compared with when the thin film piezoelectric body is formed as a single layer. Therefore, it is possible to improve ejection characteristics at the same voltage as the single layer, or to reduce a cost by replacing a component with a component having a lower rated voltage. However, in the configuration of the piezoelectric element disclosed in JP-A-2013-256137, it is difficult to achieve both the assurance of adhesion to a lower layer of the upper piezoelectric layer and the suppression of damage to the upper piezoelectric layer.

### SUMMARY

According to a preferred aspect of the present disclosure, there is provided a liquid ejecting head including: a pressure chamber substrate in which a plurality of pressure chambers are arranged in an arrangement direction; a diaphragm; a first common electrode that is provided to be shared by the plurality of pressure chambers and to which a reference voltage that does not change over time is applied; a first thin film piezoelectric body; an individual electrode that is individually provided for each of the plurality of pressure chambers so as to extend in an extending direction intersecting the arrangement direction and to which a driving voltage that changes over time is applied; a second thin film piezoelectric body; and a second common electrode that is provided to be shared by the plurality of pressure chambers and to which the reference voltage is applied, the pressure chamber substrate, the diaphragm, the first common electrode, the first thin film piezoelectric body, the individual electrode, the second thin film piezoelectric body, and the second common electrode being laminated in the stated order from a lower side to an upper side in a lamination direction intersecting the arrangement direction and the extending direction, in which when a region in the arrangement direction where the second thin film piezoelectric body overlaps all of the individual electrode, the first common electrode, and the second common electrode when viewed in the lamination direction is defined as an overlapping region, and a region in the arrangement direction where the second thin film piezoelectric body overlaps the first common electrode and the second common electrode and does not overlap the individual electrode when viewed in the lamination direction is defined as a non-overlapping region, a position of an upper surface of the second thin film piezoelectric body in the overlapping region is a first position, and the position of the upper surface of the second thin film piezoelectric body in the non-overlapping region is a second position that is located lower than the first position.

According to another preferred aspect of the present disclosure, there is provided a liquid ejecting apparatus including: the liquid ejecting head; and a voltage application circuit for applying the reference voltage and the driving voltage.

### BRIEF DESCRIPTION OF THE DRAWINGS

FIG. 1 is a schematic view illustrating a configuration of a liquid ejecting apparatus according to a first embodiment.

FIG. 2 is an exploded perspective view of a liquid ejecting head illustrated in FIG. 1.

FIG. 3 is a cross-sectional view of a part of the liquid ejecting head illustrated in FIG. 2.

FIG. 4 is an enlarged cross-sectional view of a part of the liquid ejecting head illustrated in FIG. 3.

FIG. 5 is an enlarged cross-sectional view of a part of the liquid ejecting head illustrated in FIG. 3.

FIG. 6 is a diagram illustrating a planar disposition of individual electrodes illustrated in FIG. 4.

FIG. 7 is a plan view illustrating two conductors and a plurality of lead-out wiring lines illustrated in FIG. 5.

FIG. 8 is a diagram illustrating a driving voltage and a reference voltage.

FIG. 9 is a diagram illustrating examples of applied voltages applied to a first thin film piezoelectric body and a second thin film piezoelectric body.

FIG. 10 is a plan view illustrating through-holes provided in the first thin film piezoelectric body and the second thin film piezoelectric body.

FIG. 11 is a plan view illustrating an overlapping region and a non-overlapping region of a piezoelectric element illustrated in FIG. 4.

FIG. 12 is a cross-sectional view of a piezoelectric element of a first comparative example.

FIG. 13 is a cross-sectional view of a piezoelectric element of a second comparative example.

FIG. 14 is a diagram illustrating a piezoelectric element of a modification example.

FIGS. 15A to 15E are a flowchart illustrating a manufacturing method of the piezoelectric element, which is a part of a manufacturing method of the liquid ejecting head.

FIGS. 16A to 16D are a flowchart illustrating a manufacturing method of the piezoelectric element, which is a part of the manufacturing method of the liquid ejecting head.

FIGS. 17A to 17C are a flowchart illustrating a manufacturing method of the piezoelectric element, which is a part of the manufacturing method of the liquid ejecting head.

FIG. 18 is a cross-sectional view illustrating the piezoelectric element of the modification example.

### DESCRIPTION OF EMBODIMENTS

Hereinafter, preferred embodiments according to the present disclosure will be described with reference to the accompanying drawings. In the drawings, dimensions or scales of each section are different from the actual dimensions or scales as appropriate, and some sections are schematically illustrated for easy understanding. Further, the scope of the present disclosure is not limited to these embodiments unless it is noted in the following description that the present disclosure is particularly limited. The term “equal” includes not only a case of being strictly equal but also a case of having a difference in a measurement error range. In addition, the phrase “the element α and the element β are laminated” means that the element α and the element β are arranged in an up-down direction, and whether the element α and the element β are in direct contact with each other is not a problem.

The following description will be made by using an X axis, a Y axis, and a Z axis that intersect each other, as appropriate. One direction along an X axis will be referred to as an X1 direction, and a direction opposite to the X1 direction will be referred to as an X2 direction. Directions opposite to each other along the Y axis will be referred to as a Y1 direction and a Y2 direction. Directions opposite to each other along the Z axis will be referred to as a Z1 direction and a Z2 direction. Viewing in a direction along the Z axis will be referred to as a “plan view”. The Z axis is typically a vertical axis. The Z1 direction is an upper side, and the Z2 direction is a lower side. However, the Z axis need not be the vertical axis. The X axis, the Y axis, and the Z axis are typically orthogonal to each other, but are not limited to this, and intersect each other at, for example, an angle within a range of, for example, 80° or more and 100° or less. In addition, hereinafter, an “arrangement direction” is a direction along the Y axis and is, specifically, the Y1 direction or the Y2 direction. An “extending direction” is a direction along the X axis and is, specifically, the X1 direction or the X2 direction. A “lamination direction” is a direction intersecting the “arrangement direction” and the “extending direction” and is, specifically, the Z1 direction.

### 1. FIRST EMBODIMENT

### 1-1. Overall Configuration of Liquid Ejecting Apparatus 100

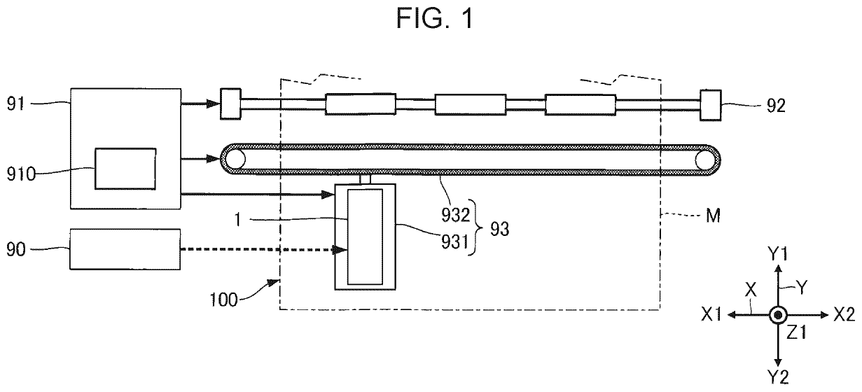

FIG. 1 is a configuration view schematically illustrating a liquid ejecting apparatus 100 according to a first embodiment. The liquid ejecting apparatus 100 is an ink jet printing apparatus that ejects ink, which is an example of liquid, to a medium M as liquid droplets. The medium M is typically printing paper. The medium M is not limited to the printing paper, and may be, for example, a printing target having any material such as a resin film or a cloth.

As illustrated in FIG. 1, the liquid ejecting apparatus 100 is equipped with a liquid container 90 for storing the ink. Examples of specific aspects of the liquid container 90 include a cartridge that can be attached to and detached from the liquid ejecting apparatus 100, a bag-shaped ink pack formed of a flexible film, and an ink tank that can be refilled with the ink. A type of the ink stored in the liquid container 90 is optional.

The liquid ejecting apparatus 100 includes a control unit 91, a transport mechanism 92, a moving mechanism 93, and a liquid ejecting head 1. The control unit 91 includes, for example, a processing circuit such as a central processing unit (CPU) or a field programmable gate array (FPGA) and a storage circuit such as a semiconductor memory, and controls the operation of each element of the liquid ejecting apparatus 100. The control unit 91 includes a voltage application circuit 910 that applies a voltage to cause a nozzle to eject the ink by controlling driving of a piezoelectric element 7, which will be described later, provided in the liquid ejecting head 1. The voltage application circuit 910 applies a reference voltage VBS and a driving voltage Com to the piezoelectric element 7, which will be described later, provided in the liquid ejecting apparatus 100.

The transport mechanism 92 transports the medium M in the Y2 direction under the control of the control unit 91. The moving mechanism 93 reciprocates the liquid ejecting head 1 in the X1 direction and the X2 direction under the control of the control unit 91. In the example illustrated in FIG. 1, the moving mechanism 93 includes a substantially box-shaped transport body 931 called a carriage that accommodates the liquid ejecting head 1, and a transport belt 932 to which the transport body 931 is fixed. The number of liquid ejecting heads 1 mounted on the transport body 931 is not limited to one, and may be more than one. The liquid container 90 may be mounted on the transport body 931 in addition to the liquid ejecting head 1.

Under the control of the control unit 91, the liquid ejecting head 1 ejects the ink supplied from the liquid container 90 to the medium M from each of a plurality of nozzles toward the Z2 direction. The ejection is performed in parallel with the transport of the medium M via the transport mechanism 92 and the reciprocating movement of the liquid ejecting head 1 via the moving mechanism 93, so that an image is formed by the ink on a surface of the medium M.

The liquid ejecting apparatus 100 includes the liquid ejecting head 1, which will be described later, and the control unit 91. The control unit 91 includes the voltage application circuit 910 that causes a nozzle N to eject the ink. Since the liquid ejecting apparatus 100 includes the liquid ejecting head 1 having the following characteristics, it is possible to suppress a decrease in reliability.

### 1-2. Overall Configuration of Liquid Ejecting Head 1

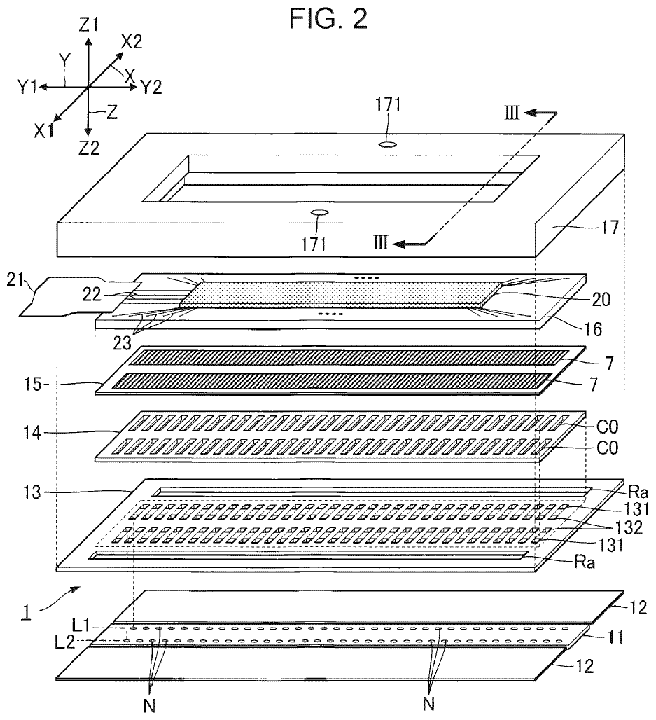

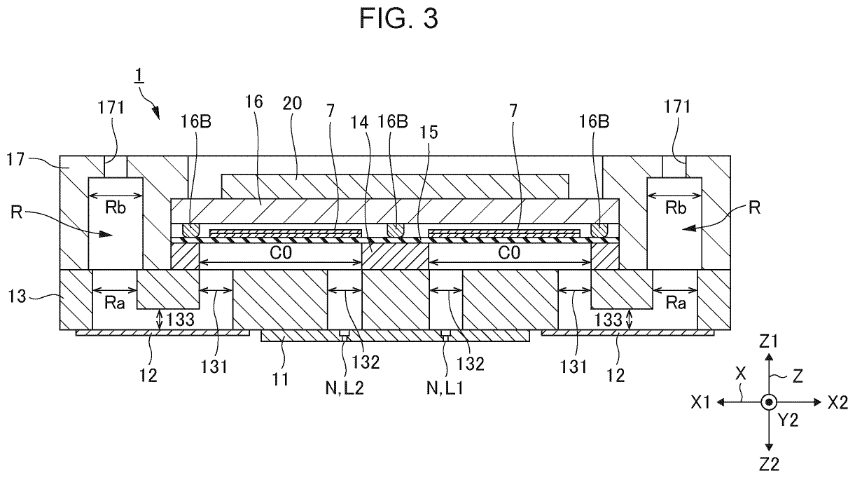

FIG. 2 is an exploded perspective view of the liquid ejecting head 1 illustrated in FIG. 1. FIG. 3 is a cross-sectional view of a part of the liquid ejecting head 1 illustrated in FIG. 2, and is a cross-sectional view taken along line III-III in FIG. 2. As illustrated in FIG. 2, the liquid ejecting head 1 includes a plurality of nozzles N arranged in the direction along the Y axis. In the example illustrated in FIG. 2, the plurality of nozzles N are divided into a first row L1 and a second row L2 arranged at intervals in the direction along the X axis. Each of the first row L1 and the second row L2 is a set of nozzles N linearly arranged in the direction along the Y axis. An element related to each nozzle N in the first row L1 and an element related to each nozzle N in the second row L2 in the liquid ejecting head 1 are substantially symmetrical with each other in the direction along the X axis. In the following description, the element corresponding to the first row L1 will be mainly described, and the description of the element corresponding to the second row L2 will be omitted as appropriate.

The positions of the plurality of nozzles N in the first row L1 and the positions of the plurality of nozzles N in the second row L2 in the direction along the Y axis may be the same as or may be different from each other. In addition, the element related to each nozzle N in one of the first row L1 and the second row L2 may be omitted.

As illustrated in FIGS. 2 and 3, the liquid ejecting head 1 includes a nozzle plate 11, a vibration absorber 12, a flow path substrate 13, a pressure chamber substrate 14, a diaphragm 15, a wiring substrate 16, a housing section 17, and a driving circuit 20. Each of the nozzle plate 11, the vibration absorber 12, the flow path substrate 13, the pressure chamber substrate 14, the diaphragm 15, the wiring substrate 16, and the housing section 17 is a plate-shaped member that is elongated in the direction along the Y axis. The nozzle plate 11, the flow path substrate 13, the pressure chamber substrate 14, the diaphragm 15, and the wiring substrate 16 are arranged in the stated order in the Z1 direction.

The nozzle plate 11 is a plate-shaped member in which the plurality of nozzles N are formed. Each of the plurality of nozzles N is a circular through-hole through which the ink passes. The nozzles N eject the ink by the vibration of the diaphragm 15. The nozzle plate 11 is bonded to the flow path substrate 13 using, for example, an adhesive.

The flow path substrate 13 is formed with a flow path for supplying the ink to the plurality of nozzles N. Specifically, in the flow path substrate 13, a space Ra, a plurality of supply flow paths 131, a plurality of communication flow paths 132, and a supply liquid chamber 133 are formed. The space Ra is an elongated opening extending in the direction along the Y axis in plan view when viewed in the direction along the Z axis. Each of the supply flow paths 131 and the communication flow paths 132 is a through-hole formed for each nozzle N. The supply liquid chamber 133 is an elongated space extending in the direction along the Y axis over the plurality of nozzles N, and allows the space Ra and the plurality of supply flow paths 131 to communicate with each other. Each of the plurality of communication flow paths 132 overlaps one nozzle N corresponding to the communication flow path 132 in plan view. The pressure chamber substrate 14 is bonded to the flow path substrate 13 using, for example, an adhesive.

In the pressure chamber substrate 14, a plurality of pressure chambers C0 are provided. The plurality of pressure chambers C0 are arranged in the direction along the Y axis as the “arrangement direction”. Each pressure chamber C0 is formed for each nozzle N, and is an elongated space extending in the direction along the X axis in plan view. The pressure chambers C0 are spaces located between the flow path substrate 13 and the diaphragm 15. The pressure chambers C0 communicate with the nozzles N via the communication flow paths 132 and communicate with the space Ra via the supply flow paths 131 and the supply liquid chamber

Each of the nozzle plate 11, the flow path substrate 13, and the pressure chamber substrate 14 is manufactured by processing a silicon single crystal substrate by using, for example, dry etching or wet etching. However, other known methods may be used as appropriate for manufacturing each of the nozzle plate 11, the flow path substrate 13, and the pressure chamber substrate 14.

The diaphragm 15 is disposed on a surface of the pressure chamber substrate 14 facing the Z1 direction. The diaphragm 15 is a plate-shaped member that can elastically vibrate.

A plurality of piezoelectric elements 7 corresponding to the nozzles N are disposed on a surface of the diaphragm 15 facing the Z1 direction. Each piezoelectric element 7 has an elongated shape extending in the direction along the X axis in plan view. The plurality of piezoelectric elements 7 correspond to the plurality of pressure chambers C0, and are arranged in the direction along the Y axis. The piezoelectric elements 7 are deformed due to the application of a voltage. When the diaphragm 15 vibrates in conjunction with the deformation, the pressure in the pressure chamber C0 fluctuates, so that the ink is ejected from the nozzle N.

The housing section 17 is a case for storing the ink to be supplied to the plurality of pressure chambers C0. As illustrated in FIG. 3, a space Rb is formed in the housing section 17. The space Rb of the housing section 17 and the space Ra of the flow path substrate 13 communicate with each other. A space formed by the space Ra and the space Rb functions as a liquid storage chamber R that is a reservoir that stores the ink to be supplied to the plurality of pressure chambers C0. The ink is supplied to the liquid storage chamber R through an inlet 171 formed in the housing section 17. The ink in the liquid storage chamber R is supplied to the pressure chambers C0 through the supply liquid chamber 133 and each supply flow path 131.

The vibration absorber 12 is a flexible film that forms a wall surface of the liquid storage chamber R. The vibration absorber 12 is a compliance substrate that absorbs the fluctuation in the pressure of the ink in the liquid storage chamber R.

The wiring substrate 16 is a plate-shaped member in which wiring lines for electrically coupling the driving circuit 20 and the plurality of piezoelectric elements 7 are formed. A surface of the wiring substrate 16 facing the Z2 direction is bonded to the diaphragm 15 via a plurality of conductive bumps 16B. On the other hand, the driving circuit 20 is mounted on a surface of the wiring substrate 16 facing the Z1 direction. The driving circuit 20 is an integrated circuit (IC) chip that outputs the driving voltage Com and the reference voltage VBS for driving each piezoelectric element 7.

As illustrated in FIG. 2, an end portion of an external wiring line 21 is bonded to the surface of the wiring substrate 16 facing the Z1 direction. The external wiring line 21 is constituted of, for example, coupling components such as flexible printed circuits (FPCs) or flexible flat cables (FFCs). The wiring substrate 16 is formed with a plurality of wiring lines 22 that electrically couple the external wiring line 21 and the driving circuit 20, and a plurality of wiring lines 23 to which the driving voltage Com and the reference voltage VBS output from the driving circuit 20 are supplied.

The wiring substrate 16 is not limited to a rigid substrate, and may be, for example, a flexible printed circuit (FPC) or a flexible flat cable (FFC). In this case, the wiring substrate 16 may also serve as the external wiring line 21.

### 1-3. Diaphragm 15

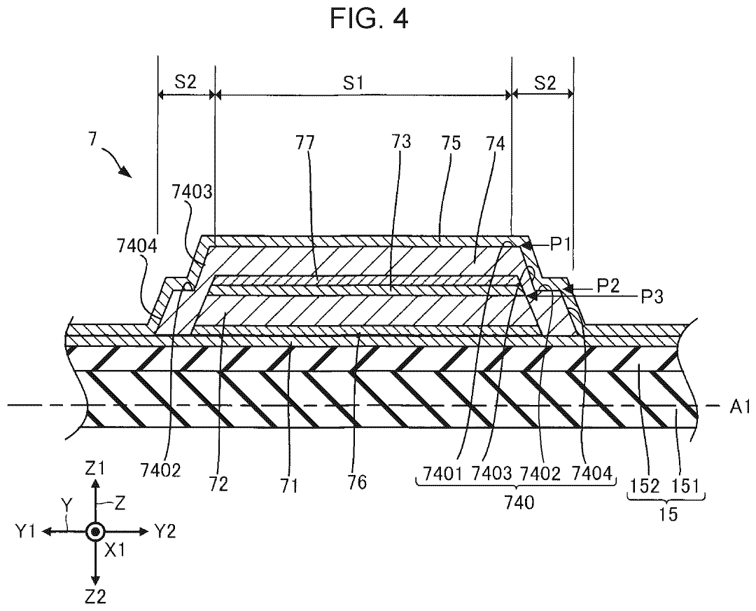

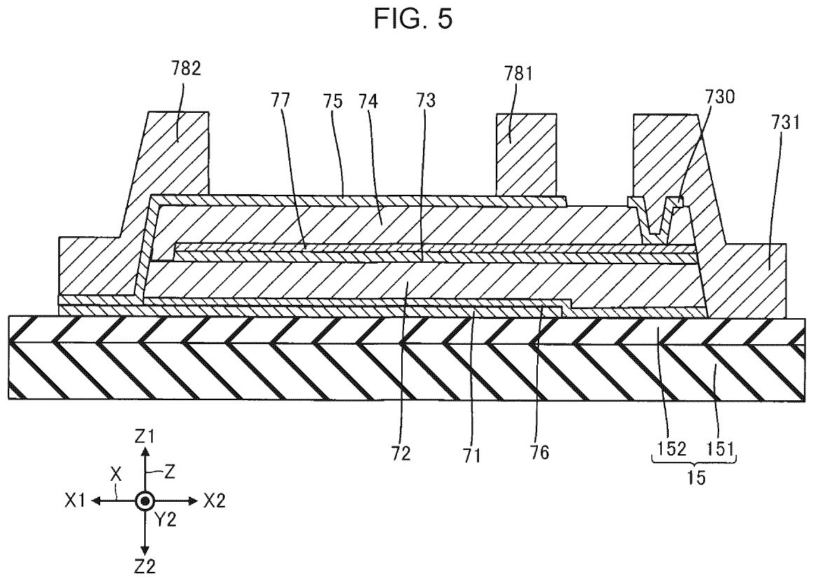

FIGS. 4 and 5 are enlarged cross-sectional views of a part of the liquid ejecting head 1 illustrated in FIG. 3. The diaphragm 15 illustrated in FIGS. 4 and 5 vibrates in response to the vibration of the piezoelectric elements 7. The diaphragm 15 has, for example, a first layer 151 and a second layer 152. The first layer 151 and the second layer 152 are laminated in the stated order from the lower side to the upper side, that is, in the Z1 direction.

For example, the first layer 151 is an elastic film formed of silicon oxide (SiO₂). The elastic film is formed by, for example, thermally oxidizing one surface of a silicon single crystal substrate. The second layer 152 is an insulating film formed of zirconium oxide (ZrO₂), for example. The insulating film is formed by, for example, forming a zirconium layer using a sputtering method and thermally oxidizing the layer. Zirconium oxide has excellent electric insulation properties, mechanical strength, and toughness. Therefore, since the diaphragm 15 has the second layer 152 containing zirconium oxide, the characteristics of the diaphragm 15 can be enhanced.

In addition, another layer such as a metal oxide may be interposed between the first layer 151 and the second layer 152. In addition, a part or the entirety of the diaphragm 15 may be formed integrally with the pressure chamber substrate 14. The diaphragm 15 may be formed of a layer of a single material. FIG. 4 illustrates a neutral axis A1 of the diaphragm 15.

### 1-4. Piezoelectric Elements 7

As illustrated in FIGS. 4 and 5, the piezoelectric elements 7 are disposed on the diaphragm 15. The piezoelectric elements 7 overlap the above-described pressure chambers C0 in plan view. The piezoelectric elements 7 each include a first common electrode 71, a first orientation control layer 76, a first thin film piezoelectric body 72, an individual electrode 73, a second orientation control layer 77, a second thin film piezoelectric body 74, and a second common electrode 75. Among these components, the first common electrode 71 and the second common electrode 75 are provided to be shared by the plurality of piezoelectric elements 7 in principle. The first thin film piezoelectric body 72 and the second thin film piezoelectric body 74 are separated between the plurality of piezoelectric elements 7 by through-holes H0, which will be described later, in a range overlapping the pressure chambers C0 in plan view when viewed in the direction along the Z axis, but are coupled to each other in a range not overlapping the pressure chambers C0 and are a continuous member. However, each of the first thin film piezoelectric body 72 and the second thin film piezoelectric body 74 need not be a continuous member. In addition, the individual electrode 73 is individually provided for each piezoelectric element 7.

The pressure chamber substrate 14, the diaphragm 15, the first common electrode 71, the first thin film piezoelectric body 72, the individual electrode 73, the second thin film piezoelectric body 74, and the second common electrode 75 are laminated in the stated order from the lower side to the upper side in the Z1 direction, which is the “lamination direction”. In addition, the first orientation control layer 76 is provided between the first thin film piezoelectric body 72 and the first common electrode 71. The second orientation control layer 77 is provided between the second thin film piezoelectric body 74 and the individual electrode 73. In addition, another layer such as a layer for enhancing adhesion may be interposed as appropriate between the plurality of layers provided in the piezoelectric elements 7 or between the piezoelectric elements 7 and the diaphragm 15. Moreover, each of the first orientation control layer 76 and the second orientation control layer 77 may be omitted as appropriate.

1-4a. First Common Electrode 71

The first common electrode 71 is provided to be shared by the plurality of above-described pressure chambers C0. The first common electrode 71 has a strip shape extending in the direction along the Y axis so as to be continuous with the plurality of pressure chambers C0. The reference voltage VBS that does not change over time is applied to the first common electrode 71.

Examples of the material of the first common electrode 71 include a metal material such as platinum (Pt), iridium (Ir), aluminum (Al), nickel (Ni), gold (Au), or copper (Cu), or an alloy. The first common electrode 71 may be a single layer or may be a plurality of layers. The first common electrode 71 has, for example, a laminated structure in which a layer formed of platinum is laminated on a layer formed of iridium.

1-4b. Individual Electrodes 73

The individual electrodes 73 extend in the direction along the Y axis as the “extending direction intersecting the arrangement direction”. The driving voltage Com that changes over time is applied to the individual electrodes 73.

Examples of the material of the individual electrodes 73 include a metal material such as platinum, iridium, aluminum, nickel, gold, or copper, or an alloy. The individual electrodes 73 may be a single layer or may be a plurality of layers.

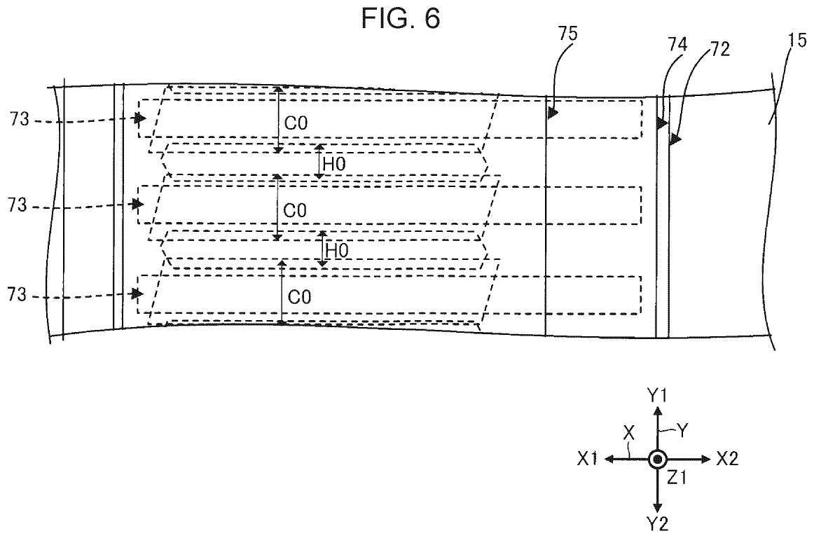

FIG. 6 is a diagram illustrating the planar disposition of the individual electrodes 73 of FIG. 4. As illustrated in FIG. 6, each individual electrode 73 has an elongated shape extending in the direction along the Y axis. The plurality of individual electrodes 73 are separated from each other and arranged along the Y axis. The individual electrodes 73 are individually provided for the plurality of pressure chambers C0. Each individual electrode 73 overlaps the corresponding one of the pressure chambers C0 when viewed in the Z1 direction.

1-4c. Second Common Electrode 75

The second common electrode 75 illustrated in FIGS. 4 and 5 is provided to be shared by the plurality of above-described pressure chambers C0. The second common electrode 75 has a strip shape extending in the direction along the Y axis so as to be continuous with the plurality of pressure chambers C0. The reference voltage VBS that does not change over time is applied to the second common electrode 75. Therefore, a common potential is applied to the first common electrode 71 and the second common electrode 75.

Examples of the material of the second common electrode 75 include a metal material such as platinum, iridium, aluminum, nickel, gold, or copper, or an alloy. The second common electrode 75 may be a single layer or may be a plurality of layers.

As illustrated in FIG. 6, the second common electrode 75 overlaps the plurality of individual electrodes 73 in plan view. The above-described first common electrode 71 also overlaps the plurality of individual electrodes 73 in plan view. As described above, the second common electrode 75 has a strip shape extending in the direction along the Y axis. Although not illustrated in detail, the second common electrode 75 is coupled to a wiring line for electrically coupling to the driving circuit 20 mounted on the wiring substrate 16 via the plurality of conductive bumps 16B described above. Therefore, the second common electrode 75 is electrically coupled to the driving circuit 20. In addition, the first common electrode 71 described above is in contact with the second common electrode 75 in a region that does not overlap the pressure chambers C0 in plan view when viewed in the direction along the Z axis, as illustrated in end portions in the Y1 direction and the Y2 direction of FIG. 4 and a side end portion in the X1 direction of FIG. 5. Due to the contact, the first common electrode 71 has the same potential as the second common electrode 75. In other words, the first common electrode 71 is electrically coupled to the driving circuit 20 via the second common electrode 75. In the present embodiment, the first common electrode 71 and the second common electrode 75 are in physical contact with each other, but another member may be interposed between the first common electrode 71 and the second common electrode 75, provided that they are electrically coupled to each other.

As illustrated in FIG. 5, two conductors 781 and 782 are disposed on the second common electrode 75. Each of the conductors 781 and 782 is a strip-shaped conductive film extending in the direction along the Y axis along an edge of the second common electrode 75 in the X1 direction or the X2 direction. The conductors 781 and 782 are formed of, for example, a conductive material having an electrically low resistance, such as gold. The conductors 781 and 782 suppress the voltage drop of the reference voltage VBS in the second common electrode 75. In addition, the conductors 781 and 782 also function as a weight for defining a vibration region of the diaphragm 15. In addition, the conductors 781 and 782 may be omitted.

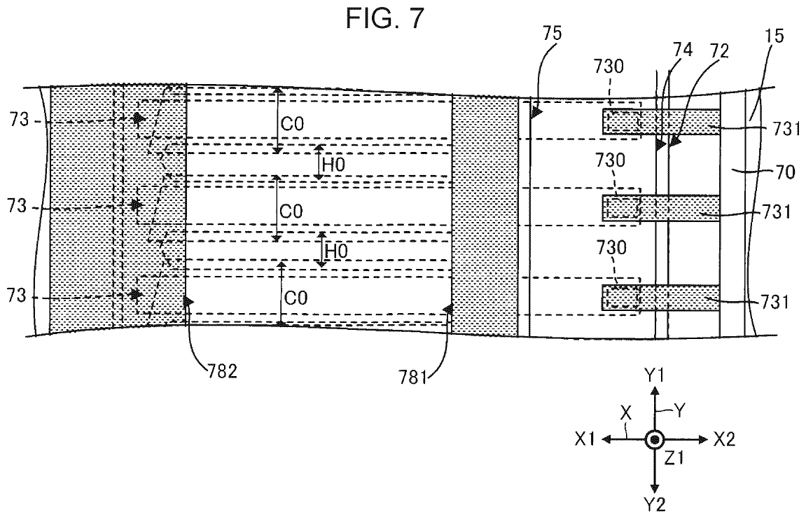

FIG. 7 is a plan view illustrating the two conductors 781 and 782 and a plurality of lead-out wiring lines 731 illustrated in FIG. 5. In addition, in FIG. 7, for easy understanding, dots are added to the two conductors 781 and 782 and the plurality of lead-out wiring lines 731.

As illustrated in FIGS. 5 and 7, one end of each individual electrode 73 in a longitudinal direction along the X axis is coupled to the corresponding one of the lead-out wiring lines 731 via a coupling wiring line 730. The lead-out wiring lines 731 are coupled to a wiring line 70 extending along the Y axis. The wiring line 70 is electrically coupled to the driving circuit 20 mounted on the wiring substrate 16 via the plurality of conductive bumps 16B described above. Although not illustrated in detail, the first common electrode 71 is electrically coupled to the driving circuit 20 mounted on the wiring substrate 16 via the plurality of conductive bumps 16B described above, in the same manner as the second common electrode 75.

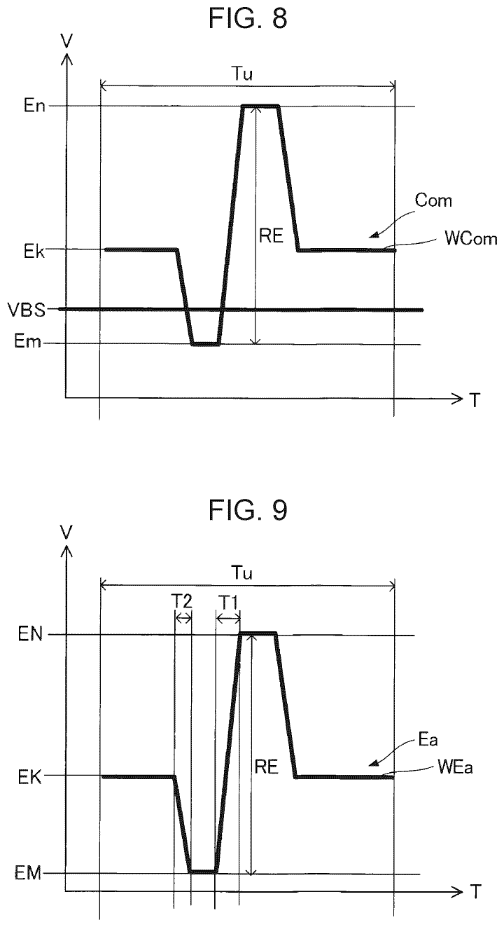

FIG. 8 is a diagram illustrating the driving voltage Com and the reference voltage VBS. In FIG. 8, the horizontal axis represents time, and the vertical axis represents voltage [V].

The voltage application circuit 910 described above applies a voltage to the piezoelectric elements 7. Specifically, the voltage application circuit 910 applies the voltage to the first thin film piezoelectric body 72 via the first common electrode 71 and the individual electrodes 73, and the first thin film piezoelectric body 72 is deformed in accordance with the voltage applied between the first common electrode 71 and the individual electrodes 73. Similarly, the voltage application circuit 910 applies the voltage to the second thin film piezoelectric body 74 via the second common electrode 75 and the individual electrodes 73, and the second thin film piezoelectric body 74 is deformed in accordance with the voltage applied between the second common electrode 75 and the individual electrodes 73.

The driving voltage Com corresponding to an ejection amount of the ink is applied to the individual electrodes 73. The driving voltage Com changes over time. The driving voltage Com includes a driving waveform WCom. The driving waveform WCom is repeated in a unit period Tu. The driving waveform WCom includes an intermediate voltage Ek, a maximum voltage En, and a minimum voltage Em. The maximum voltage En is a maximum value of the driving voltage Com. The minimum voltage Em is a minimum value of the driving voltage Com. The driving waveform WCom decreases from the intermediate voltage Ek to the minimum voltage Em to maintain the minimum voltage Em, then increases from the minimum voltage Em to the maximum voltage En to maintain the maximum voltage En, and then decreases to the intermediate voltage Ek. The driving waveform WCom illustrated in FIG. 8 is merely an example, and the driving voltage Com may have another waveform.

The constant reference voltage VBS is applied to each of the first common electrode 71 and the second common electrode 75 regardless of the ejection amount of the ink. The reference voltage VBS does not change over time and is constant. In the illustrated example, the reference voltage VBS is a voltage value higher than the minimum voltage Em of the driving voltage Com, but the present disclosure is not limited to this. In addition, the reference voltage VBS may be a GND potential, that is, 0 V.

FIG. 9 is a diagram illustrating an example of an applied voltage Ea applied to the first thin film piezoelectric body 72 and the second thin film piezoelectric body 74. The applied voltage Ea illustrated in FIG. 9 is obtained by subtracting the reference voltage VBS from the driving voltage Com illustrated in FIG. 8 at each time.

By applying the driving voltage Com and the reference voltage VBS, a voltage of a difference between the driving voltage Com and the reference voltage VBS is applied to the first thin film piezoelectric body 72 between the first common electrode 71 and the individual electrodes 73, and the first thin film piezoelectric body 72 is deformed. Similarly, by applying the driving voltage Com and the reference voltage VBS, a voltage of a difference between the driving voltage Com and the reference voltage VBS is applied to the second thin film piezoelectric body 74 between the second common electrode 75 and the individual electrodes 73, and the second thin film piezoelectric body 74 is deformed.

In FIG. 9, the horizontal axis represents time, and the vertical axis represents voltage [V]. The applied voltage Ea includes a waveform WEa. The waveform WEa includes an intermediate voltage EK, a maximum voltage EN, and a minimum voltage EM. The maximum voltage EN is a difference between the maximum voltage En of the driving voltage Com and the reference voltage VBS. The minimum voltage EM is a difference between the minimum voltage Em of the driving voltage Com and the reference voltage VBS. The waveform WEa illustrated in FIG. 9 is merely an example, and changes depending on the driving voltage Com and the reference voltage VBS.

Since the reference voltage VBS is constant, a voltage range RE of the applied voltage Ea is equal to a voltage range RE of the driving voltage Com.

1-4d. First Thin Film Piezoelectric Body 72 and Second Thin Film Piezoelectric Body 74

The first thin film piezoelectric body 72 illustrated in FIGS. 4 and 5 is disposed between the first common electrode 71 and the individual electrodes 73, and is deformed in accordance with a potential difference between the first common electrode 71 and the individual electrodes 73. The first thin film piezoelectric body 72 is formed of a composite oxide. The first orientation control layer 76 is disposed at a lower layer of the first thin film piezoelectric body 72. The orientation of the first thin film piezoelectric body 72 is controlled by the first orientation control layer 76.

As illustrated in FIG. 4, an upper surface of the first thin film piezoelectric body 72 includes a portion that is parallel to an X-Y plane and is in contact with the individual electrodes 73, and a portion that is inclined with respect to the X-Y plane and is in contact with the second thin film piezoelectric body 74.

In addition, the second thin film piezoelectric body 74 is disposed between the second common electrode 75 and the individual electrodes 73, and is deformed in accordance with a potential difference between the second common electrode 75 and the individual electrodes 73. In addition, the second thin film piezoelectric body 74 is formed of a composite oxide. The second orientation control layer 77 is disposed at a lower layer of the second thin film piezoelectric body 74. The orientation of the second thin film piezoelectric body 74 is controlled by the second orientation control layer 77 at the lower layer.

As illustrated in FIG. 4, the second thin film piezoelectric body 74 has an upper surface 740. The upper surface 740 is in contact with the second common electrode 75. The upper surface 720 includes a first upper surface portion 7401, a second upper surface portion 7402, a first inclined surface 7403, and a second inclined surface 7404. Each of the first upper surface portion 7401 and the second upper surface portion 7402 is a surface that is parallel to the X-Y plane and is orthogonal to the Z1 direction. The first inclined surface 7403 couples the first upper surface portion 7401 and the second upper surface portion 7402, and is inclined with respect to the first upper surface portion 7401 and the second upper surface portion 7402. The second inclined surface 7404 is coupled to the second upper surface portion 7402, and is inclined with respect to the second upper surface portion 7402.

The first upper surface portion 7401 is located in the Z1 direction with respect to the second upper surface portion 7402. The position of the first upper surface portion 7401 in the Z1 direction is defined as a first position P1, and the position of the second upper surface portion 7402 in the Z1 direction is defined as a second position P2. Therefore, the first position P1 is located in the Z1 direction with respect to the second position P2. The first inclined surface 7403 is located lower than the first position P1. The second inclined surface 7404 is located lower than the second position P2.

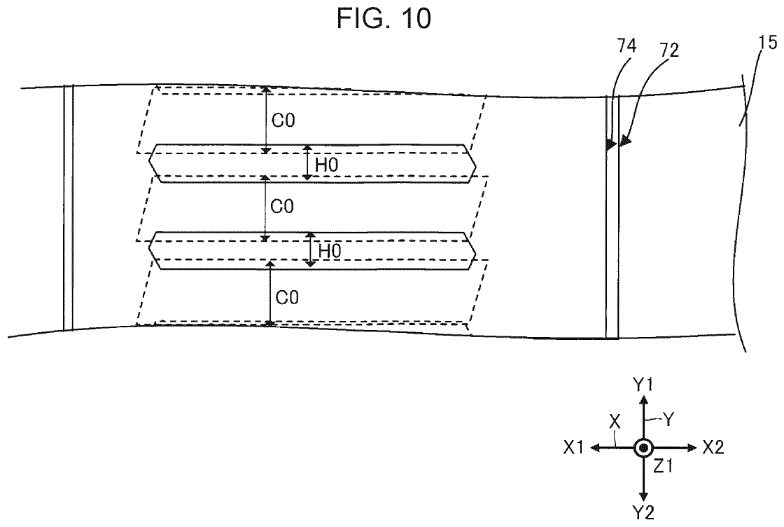

FIG. 10 is a plan view illustrating the through-holes H0 provided in the first thin film piezoelectric body 72 and the second thin film piezoelectric body 74. As illustrated in FIG. 10, the first thin film piezoelectric body 72 and the second thin film piezoelectric body 74 are provided with the through-holes H0 in a region corresponding to a gap between the pressure chambers C0 adjacent to each other when viewed in the Z1 direction. The first thin film piezoelectric body 72 and the second thin film piezoelectric body 74 are separated by the through-hole H0 for each pressure chamber C0.

As described above, each of the first thin film piezoelectric body 72 and the second thin film piezoelectric body 74 is formed of a composite oxide. Specifically, each of the first thin film piezoelectric body 72 and the second thin film piezoelectric body 74 is formed of a piezoelectric material having a perovskite crystal structure.

Examples of the piezoelectric material include lead titanate (PbTiO₃), lead zirconate titanate (PZT: Pb(Zr,Ti)O₃), lead zirconite (PbZrO₃), lead lanthanum titanate ((Pb, La), TiO₃), lead lanthanum titanate zirconate ((Pb, La)(Zr, Ti)O₃), lead zirconite niobate titanate (Pb(Zr, Ti, Nb)O₃), and lead magnesium niobate zirconite titanate (Pb(Zr, Ti)(Mg, Nb)O₃). Among these, lead zirconate titanate (PZT) is suitably used as a constituent material of the thin film piezoelectric bodies. In addition, the thin film piezoelectric bodies may contain a small amount of other elements such as impurities. Each of the first thin film piezoelectric body 72 and the second thin film piezoelectric body 74 may be a single layer or may be a plurality of layers.

The first thin film piezoelectric body 72 and the second thin film piezoelectric body 74 may be formed of the same material as each other, but it is preferable that the first thin film piezoelectric body 72 and the second thin film piezoelectric body 74 are formed of different materials. The desired physical properties of the first thin film piezoelectric body 72 and the second thin film piezoelectric body 74 may differ depending on the piezoelectric elements 7 to be used. Therefore, when the first thin film piezoelectric body 72 and the second thin film piezoelectric body 74 are formed of the same material, the degree of freedom in design is reduced, and it is difficult to set each of the first thin film piezoelectric body 72 and the second thin film piezoelectric body 74 to an optimum physical property value. When the first thin film piezoelectric body 72 and the second thin film piezoelectric body 74 are formed of different materials, it is possible to design the optimum physical property value for each of the first thin film piezoelectric body 72 and the second thin film piezoelectric body 74. Therefore, the desired piezoelectric elements 7 can be found.

From another viewpoint, it is preferable that the first thin film piezoelectric body 72 and the second thin film piezoelectric body 74 have the same material as each other. When the first thin film piezoelectric body 72 and the second thin film piezoelectric body 74 are formed of the same material, the manufacturing is easy, and it is easy to design desired physical properties by, for example, simply controlling a film thickness.

Each of the first thin film piezoelectric body 72 and the second thin film piezoelectric body 74 is a thin film. Specifically, the thin film in the present embodiment has a thickness of at least 5 μm or less, more preferably 2 μm or less. The thicknesses of the first thin film piezoelectric body 72 and the second thin film piezoelectric body 74 may be the same as each other or different from each other.

In the piezoelectric elements 7 including the first thin film piezoelectric body 72 and the second thin film piezoelectric body 74, the piezoelectric elements 7 and the diaphragm 15 are deformed to be bent in the Z1 direction, in an expansion period T2 illustrated in FIG. 9 in which the voltage decreases from the intermediate voltage EK to the minimum voltage EM to expand the pressure chambers C0. That is, the piezoelectric elements 7 are deformed upward so as to expand the pressure chambers C0. As a result, the ink is taken into the pressure chambers C0. Next, the piezoelectric elements 7 and the diaphragm 15 are deformed to be bent in the Z2 direction, in a contraction period T1 in which the voltage increases from the minimum voltage EM to the maximum voltage EN to contract the pressure chambers C0. That is, the piezoelectric elements 7 are deformed downward so as to contract the pressure chambers C0. As a result, the ink in the pressure chambers C0 is ejected from the nozzle.

1-4e. First Orientation Control Layer 76 and Second Orientation Control Layer 77

As illustrated in FIGS. 4 and 5, the first orientation control layer 76 is provided between the first thin film piezoelectric body 72 and the first common electrode 71. The second orientation control layer 77 is provided between the second thin film piezoelectric body 74 and the individual electrodes 73. In addition, the first orientation control layer 76 controls the orientation of the first thin film piezoelectric body 72, and the second orientation control layer 77 controls the orientation of the second thin film piezoelectric body 74.

Providing the first orientation control layer 76 and the second orientation control layer 77 makes it possible to perform the orientation control on each of the first thin film piezoelectric body 72 and the second thin film piezoelectric body 74. That is, the first orientation control layer 76 can preferentially orient the crystal of the first thin film piezoelectric body 72 in a predetermined plane orientation or adjust the degree of orientation of the predetermined plane orientation. Similarly, the second orientation control layer 77 can preferentially orient the crystal of the second thin film piezoelectric body 74 in a predetermined plane orientation or to adjust the degree of orientation of the predetermined plane orientation.

For example, the first orientation control layer 76 is capable of improving the piezoelectric characteristics of the piezoelectric elements 7 by preferentially orienting the crystal of the first thin film piezoelectric body 72 to a (100) plane, as compared with when the crystal is preferentially oriented to a (110) plane. Similarly, the second orientation control layer 77 is capable of improving the piezoelectric characteristics of the piezoelectric elements 7 by preferentially orienting the crystal of the second thin film piezoelectric body 74 to a (100) plane, as compared with when the crystal is preferentially oriented to a (110) plane. Therefore, it is possible to increase the displacement efficiency of the piezoelectric elements 7.

In addition, the crystal orientation of each of the first thin film piezoelectric body 72 and the second thin film piezoelectric body 74 can be analyzed by analyzing an X-ray diffraction intensity curve of an X-ray diffraction (XRD) method. In addition, the preferential orientation to the (100) plane means that the peak intensity corresponding to the (100) plane is higher than the peak intensity corresponding to the other direction, specifically, the (110) plane. In particular, when 50% or more, and further 80% or more of the crystals of the thin film piezoelectric bodies are oriented to the (100) plane, it is possible to increase the displacement efficiency of the piezoelectric elements 7.

For example, the first orientation control layer 76 can adjust the degree of orientation of the crystal of the first thin film piezoelectric body 72 to the (100) plane. Similarly, the first orientation control layer 76 can adjust the degree of orientation of the crystal of the first thin film piezoelectric body 72 to the (100) plane. Therefore, the degree of orientation of each of the first thin film piezoelectric body 72 and the second thin film piezoelectric body 74 can be set to a desired degree of orientation, by providing the first orientation control layer 76 that controls the orientation of the first thin film piezoelectric body 72 and the second orientation control layer 77 that controls the orientation of the second thin film piezoelectric body 74. Therefore, it is possible to set the optimum physical property value for each of the first thin film piezoelectric body 72 and the second thin film piezoelectric body 74.

Each of the first orientation control layer 76 and the second orientation control layer 77 contains, for example, titanium (Ti) or a composite oxide having a perovskite structure. The composite oxide having the perovskite structure contains, for example, any of nickel (Ni), lanthanum (La), bismuth (Bi), lead (Pb), titanium (Ti), and iron (Fe) as a constituent element.

Specifically, examples of the composite oxide having the perovskite structure include lead titanate (PbTiO₃), lanthanum nickelate (LaNiO₃), PbₓBi₍ₐ₋ₓ₎Fe_{y}Ti_{(b-y)}O_{z}, and PbₓFe_{y}Ti_{(1-y)}O_{z}. Each of the first orientation control layer 76 and the second orientation control layer 77 may be a single layer or may be a plurality of layers. Therefore, the material of each of the first orientation control layer 76 and the second orientation control layer 77 may be one type or may be a plurality of types.

In the above-described PbₓBi₍ₐ₋ₓ₎Fe_{y}Ti_{(b-y)}O_{z}, a>x and b>y. In addition, it is preferable that x/(a−x) satisfies 0.04<x/(a−x)<1.40. Furthermore, in order to perform the orientation to the (100) plane, it is more preferable that x/(a−x)<0.72. It is preferable that b=1, and it is preferable that a/b satisfies 0.8< (a/b)<1.4. In addition, it is preferable that z satisfies 2.8<z<3.2.

Examples satisfying these preferable ranges include, for example, a=1.2, b=1.0, x=0.1, and y=0.5.

In addition, in PbₓFe_{y}Ti_{(1-y)}O_{z}, 1.00≤x<2.00. In order to perform the orientation to the (100) plane, it is preferable that 1.00≤x<1.50. Further, 0.10≤y≤0.90. In order to perform the orientation to the (100) plane, it is preferable that 0.20≤y≤0.80. Further, z is typically 3.00. However, z need not be 3.00.

Hereinafter, PbₓBi₍ₐ₋ₓ₎Fe_{y}Ti_{(b-y)}O_{z} will be simply referred to as “PbBiFeTiO”. PbₓFe_{y}Ti_{(1-y)}O_{z} will be simply referred to as “PbFeTiO”.

In particular, it is preferable that each of the first orientation control layer 76 and the second orientation control layer 77 contains Bi, Fe, Ti, and Pb. Specifically, for example, it is preferable that each of the first orientation control layer 76 and the second orientation control layer 77 is PbBiFeTiO. PbBiFeTiO has excellent performance in the orientation control on the thin film piezoelectric bodies as compared with PbFeTiO, lanthanum nickelate, and titanium. Therefore, for example, the degree of orientation of the second thin film piezoelectric body 74 to the (100) plane can be increased. Therefore, it is possible to increase the piezoelectric efficiency of the second thin film piezoelectric body 74.

In addition, the second orientation control layer 77 containing PbBiFeTiO has a self-orientation property that is a property of being self-oriented in a predetermined plane orientation. Therefore, when the second orientation control layer 77 is PbBiFeTiO, the second orientation control layer 77 is less likely to be affected by the plane orientation of a base of the second orientation control layer 77. Therefore, the second orientation control layer 77 is self-oriented in the predetermined plane orientation without being affected by the base regardless of the plane orientation of the base. Therefore, the second thin film piezoelectric body 74 can be oriented in the same plane orientation as the second orientation control layer 77 under the influence of the plane orientation of the second orientation control layer 77. Specifically, the second orientation control layer 77 is oriented to the (100) plane. The orientation of the second thin film piezoelectric body 74 is controlled to the (100) plane by the second orientation control layer 77. If the second orientation control layer 77 does not have the self-orientation property, it is affected by the plane orientation of the base, and is oriented in a plane orientation other than the predetermined plane orientation.

From the viewpoint of the self-orientation property, the first orientation control layer 76 and the second orientation control layer 77 may be PbFeTiO. PbFeTiO has the self-orientation property in the same manner as PbBiFeTiO. It is considered that a layer formed of Ti and a layer formed of PbTiOx do not have the self-orientation property.

In addition, the thickness of the first orientation control layer 76 is less than the thickness of the first thin film piezoelectric body 72, and the thickness of the second orientation control layer 77 is less than the thickness of the second thin film piezoelectric body 74. Each thickness is an average length along the Z axis. The thickness of the first orientation control layer 76 and the thickness of the second orientation control layer 77 are not particularly limited, but are, for example, in a range of 20 nm or more and 200 nm or less. The respective thicknesses of the first orientation control layer 76 and the second orientation control layer 77 may be the same as each other or may be different from each other.

1-4f. Overlapping Region S1 and Non-Overlapping Region S2

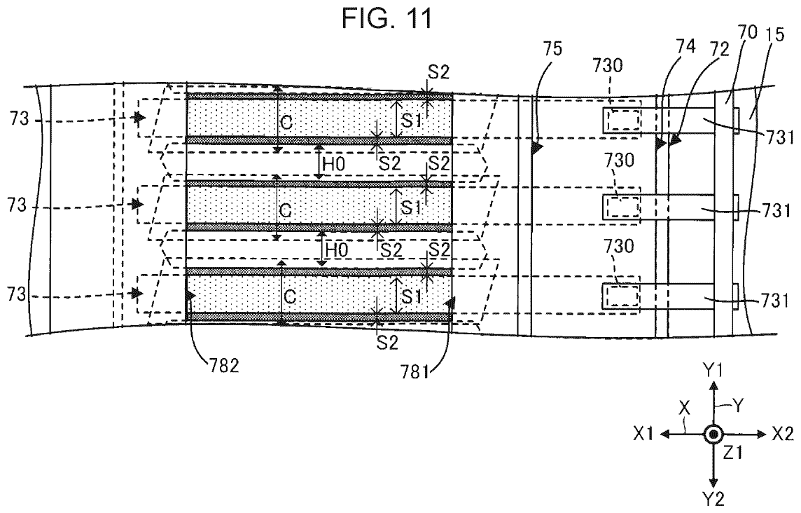

FIG. 11 is a plan view illustrating an overlapping region S1 and a non-overlapping region S2 of the piezoelectric elements 7 illustrated in FIG. 4. In FIG. 11, for easy understanding, dots are added to the overlapping region S1 and the non-overlapping region S2.

As illustrated in FIGS. 4 and 11, the piezoelectric elements 7 include the overlapping region S1 and the non-overlapping region S2. The overlapping region S1 is a region in the Y1 direction, which is the “arrangement direction”, where the second thin film piezoelectric body 74 overlaps all of the individual electrodes 73, the first common electrode 71, and the second common electrode 75 when viewed in the Z1 direction, which is the “lamination direction”. The non-overlapping region S2 is a region in the Y1 direction where the second thin film piezoelectric body 74 overlaps the first common electrode 71 and the second common electrode 75 and does not overlap the individual electrodes 73 when viewed in the Z1 direction. The overlapping region S1 and the non-overlapping region S2 are located at the same position in the X direction and at positions adjacent to each other in the Y1 direction.

In the present embodiment, the overlapping region S1 and the non-overlapping region S2 are provided in a region between the conductors 781 and 782. As described above, the two conductors 781 and 782 also function as a weight for defining the vibration region of the diaphragm 15. The overlapping region S1 is an active portion as a region in which the piezoelectric elements 7 vibrate. In contrast, the non-overlapping region S2 is an inactive portion.

As illustrated in FIG. 11, each of the overlapping region S1 and the non-overlapping region S2 extends along the X axis. In addition, a plurality of overlapping regions S1 are provided. When viewed in the Z1 direction, the plurality of overlapping regions S1 are separated from each other, and are arranged in the Y1 direction, similarly to the plurality of individual electrodes 73. In addition, a plurality of non-overlapping regions S2 are provided.

Two non-overlapping regions S2 are provided with one overlapping region S1 interposed therebetween when viewed in the Z1 direction. Therefore, in one piezoelectric element 7, one overlapping region S1 is located between two non-overlapping regions S2 when viewed in the Z1 direction. The two non-overlapping regions S2 may be coupled to each other in the Y1 direction, which is the arrangement direction.

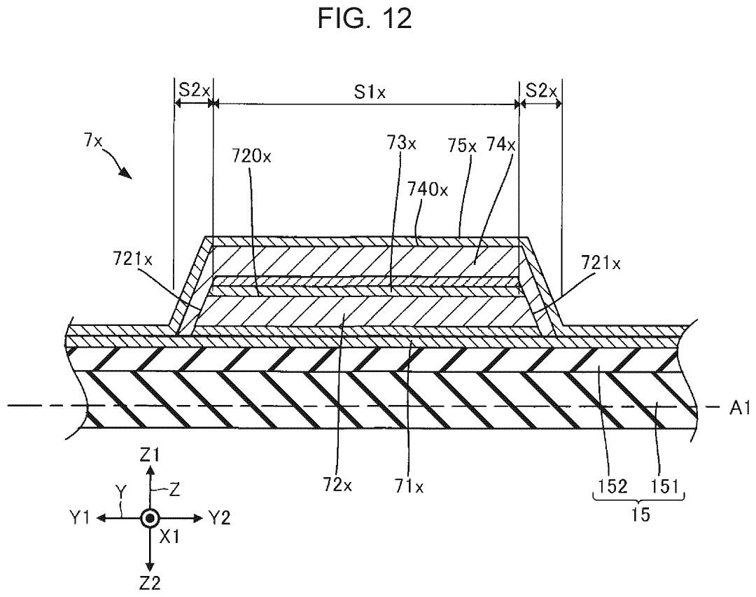

FIG. 12 is a cross-sectional view of a piezoelectric element 7x of a first comparative example. As illustrated in FIG. 12, in the piezoelectric element 7x of the first comparative example, an upper surface 740x of a second thin film piezoelectric body 74x is a flat surface and does not have a step. In FIG. 12, an active portion S1x and an inactive portion S2x of the piezoelectric element 7x are illustrated.

In the piezoelectric element 7x of FIG. 12, the length of the inactive portion S2x along the Y axis is uniformly reduced to be the same as the length of the inactive portions S2 of the piezoelectric elements 7 on the Z1 side (upper surface side) in FIG. 4 along the Y axis. When the length of the second thin film piezoelectric body 74x along the Y axis in the inactive portion S2x is reduced in this manner, the second thin film piezoelectric body 74x may not be stably bonded to a first common electrode 71x and may be peeled off. In the first place, when the piezoelectric body is a single layer, the peeling-off of the piezoelectric body with respect to the electrode disposed thereunder hardly occurs. This is because the piezoelectric body of the single layer is bonded to the electrode disposed thereunder over a wide range. However, when the piezoelectric body is a laminated body, the contact area between a first thin film piezoelectric body 72x and the first common electrode 71x is wide, but the contact area between the second thin film piezoelectric body 74x and the first common electrode 71x is small. Therefore, the solid bonding force of the first thin film piezoelectric body 72x to the first common electrode 71x is sufficient, but the solid bonding force of the second thin film piezoelectric body 74x to the first common electrode 71x is not sufficient. For this reason, it is considered that it is difficult for the first thin film piezoelectric body 72x to peel off from the first common electrode 71x, but the second thin film piezoelectric body 74x is peeled off from the first common electrode 71x.

The second thin film piezoelectric body 74x is in contact with an individual electrode 73x over a wide range, but the individual electrode 73x is not integrally bonded to the diaphragm 15, and thus receives an influence of the film stress from the first thin film piezoelectric body 72x and the second thin film piezoelectric body 74x from both surfaces. Therefore, it is considered that the structure is unstable, and does not significantly contribute to the solid bonding.

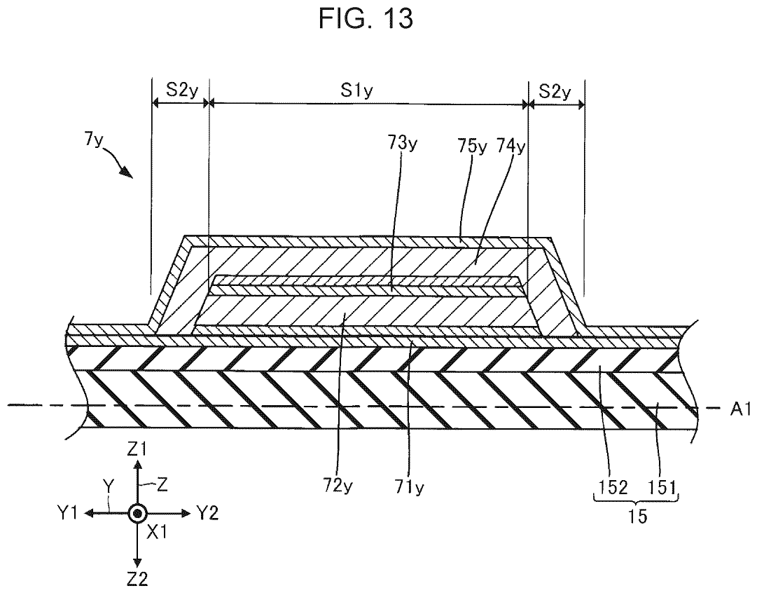

FIG. 13 is a cross-sectional view of a piezoelectric element 7y of a second comparative example. In FIG. 13, an active portion Sly and an inactive portion S2y of the piezoelectric element 7y are illustrated. In order to solve the problem of the first comparative example described above, the length of a second thin film piezoelectric body 74y in the inactive portion S2y along the Y axis is increased, as in the piezoelectric element 7y of the second comparative example illustrated in FIG. 13. In this way, the contact area between the second thin film piezoelectric body 74y and a first common electrode 71y can be ensured to some extent. In the piezoelectric element 7y of FIG. 13, the length of the inactive portion S2y along the Y axis is uniformly increased to be the same as the length of the inactive portions S2 of the piezoelectric elements 7 on the Z2 side (lower surface side) in FIG. 4 along the Y axis.

However, in this case, it is found that damage occurs in an upper portion of the second thin film piezoelectric body 74y in the inactive portion S2y. The following two causes are considered responsible for the damage to the upper portion.

First, the strain generated at a boundary between the active portion Sly and the inactive portion S2y is considered responsible for the damage. At the boundary between the active portion Sly and the inactive portion S2y, the strain may be generated because one of the active portion Sly and the inactive portion S2y is displaced and the other thereof is not displaced. By laminating the piezoelectric body, the film thickness of the piezoelectric element 7y in the Z direction is thickened overall as compared with when the piezoelectric body is a single layer. In addition, the second thin film piezoelectric body 74y located above a first thin film piezoelectric body 72y is far from the neutral axis A1 of the diaphragm 15. Therefore, it is considered that the above-described strain is likely to be generated at the boundary between the active portion Sly and the inactive portion S2y in the second thin film piezoelectric body 74y.

Second, the potential difference is applied to the second thin film piezoelectric body 74y in the inactive portion S2y, which is considered responsible for the damage. A lower portion of the second thin film piezoelectric body 74y in the inactive portion S2y is close to the first common electrode 71y and a second common electrode 75y having the same potential, and is surrounded by the first common electrode 71y and the second common electrode 75y. Therefore, the lower portion of the second thin film piezoelectric body 74y has substantially a potential difference of 0. On the other hand, the upper portion of the second thin film piezoelectric body 74y is close to the second common electrode 75y, but is far from the first common electrode 71y. Therefore, the influence of the first common electrode 71y applied to the upper portion of the second thin film piezoelectric body 74y is small. In addition, the upper portion of the second thin film piezoelectric body 74y is closer to an individual electrode 73y than the first common electrode 71y. The individual electrode 73y and the second common electrode 75y have potentials different from each other. Therefore, the influence of the potential difference between the individual electrode 73y and the second common electrode 75y is applied to the upper portion of the second thin film piezoelectric body 74y. Therefore, even in the inactive portion S2y, the potential difference is applied to the second thin film piezoelectric body 74y. This phenomenon is particularly remarkable when the upper portion of the second thin film piezoelectric body 74y is provided in an inclined manner so as to be gradually raised toward the inside in the Y axis direction (the side on which the first thin film piezoelectric body 72y is located) in most of the inactive portion S2y as illustrated in FIG. 13.

As compared with the second comparative example described above, in the piezoelectric elements 7 of the present embodiment, the second position P2 of the upper surface 740 of the second thin film piezoelectric body 74 in the non-overlapping region S2 is located lower than the first position P1 of the upper surface 740 of the second thin film piezoelectric body 74 in the overlapping region S1. The upper surface 740 has a step. Since the second position P2 is located lower than the first position P1, the thickness of the inactive portion of the second thin film piezoelectric body 74, that is, the non-overlapping region S2, of the piezoelectric elements 7 of the present embodiment is smaller than that of the second comparative example. The thickness is the length in the Z1 direction. Therefore, in the piezoelectric elements 7 of the present embodiment, the upper portion of the second thin film piezoelectric body 74y of the second comparative example can be omitted, or the volume of the upper portion of the second thin film piezoelectric body 74 can be made extremely small. For this reason, it is possible to suppress the occurrence of the above-described damage that can occur in the second thin film piezoelectric body 74y.

In addition, for the lower portion of the second thin film piezoelectric body 74, the peeling-off of the second thin film piezoelectric body 74 from the first common electrode 71 can be suppressed by ensuring a certain length of the second thin film piezoelectric body 74x in the inactive portion, that is, the non-overlapping region S2 along the Y axis. Therefore, with the piezoelectric elements 7 of the present embodiment, it is possible to achieve both the assurance of the adhesion to the first common electrode 71 located at the lower layer of the second thin film piezoelectric body 74 and the suppression of the damage to the second thin film piezoelectric body 74. Therefore, the reliability of the piezoelectric element 7 can be improved, and thus the reliability of the liquid ejecting head 1 can be improved.

As illustrated in FIG. 4, the overlapping region S1 has a first upper surface portion 7401 that is a portion in which the position of the upper surface 740 of the second thin film piezoelectric body 74 is constant at the first position P1. The non-overlapping region S2 has a second upper surface portion 7402 that is a portion in which the position of the upper surface 740 of the second thin film piezoelectric body 74 is constant at the second position P2. The piezoelectric elements 7 in which the second upper surface portion 7402 is a flat surface and the upper surface 740 has a step in addition to the first upper surface portion 7401 can be manufactured by processing.

Further, the first inclined surface 7403 located at the boundary between the overlapping region S1 and the non-overlapping region S2 is inclined with respect to the Z1 direction. The first upper surface portion 7401 of the upper surface 740 is located inside two second upper surface portions 7402 when viewed in the Z1 direction. From another viewpoint, at the boundary between the overlapping region S1 and the non-overlapping region S2, the position of the upper surface 740 of the second thin film piezoelectric body 74 is gradually lowered from the first position P1 to the second position P2. Therefore, a corner portion formed by the first upper surface portion 7401 and the first inclined surface 7403 of the upper surface 740 of the second thin film piezoelectric body 74 has an obtuse angle. Since the corner portion has an obtuse angle, it is possible to suppress a possibility that a crack is generated due to stress concentration at the corner portion as compared with when the corner portion is 90° or less.

In addition, each of two second inclined surfaces 7404 is inclined with respect to the Z1 direction, and the two second inclined surfaces 7404 are inclined to spread from the second upper surface portion 7402 toward the first common electrode 71. From another viewpoint, at a portion, in the non-overlapping region S2, that is located on a side farther from the individual electrodes 73 in the Y1 direction that is the “arrangement direction” than a portion at which the position of the upper surface 740 of the second thin film piezoelectric body 74 is the second position P2, the position of the upper surface 740 of the second thin film piezoelectric body 74 is gradually lowered from the second position P2. Therefore, a corner portion formed by the second upper surface portion 7402 and the second inclined surface 7404 of the upper surface 740 of the second thin film piezoelectric body 74 has an obtuse angle. Since the corner portion has an obtuse angle, it is possible to suppress a possibility that a crack is generated due to stress concentration at the corner portion as compared with when the corner portion is 90° or less.

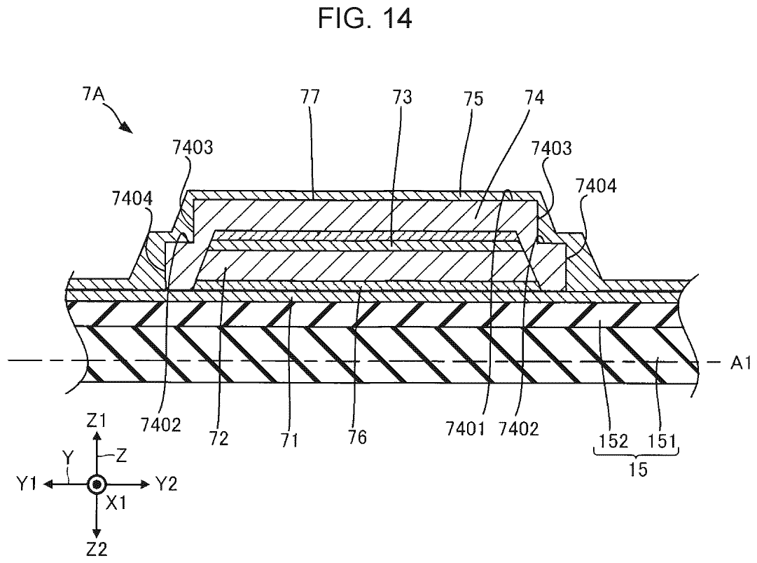

FIG. 14 is a diagram illustrating a piezoelectric element 7A of a modification example. In the piezoelectric element 7A illustrated in FIG. 14, the corner portion formed by the first upper surface portion 7401 and the first inclined surface 7403 of the upper surface 740 of the second thin film piezoelectric body 74 is 90°. In addition, the corner portion formed by the second upper surface portion 7402 and the second inclined surface 7404 of the upper surface 740 of the second thin film piezoelectric body 74 is 90°. As compared with the piezoelectric element 7A of the modification example, the piezoelectric elements 7 of the present embodiment illustrated in FIG. 4 can suppress the possibility that the crack is generated due to the stress concentration at the corner portion, as described above.

Even with the piezoelectric element 7A of FIG. 14, it is possible to achieve both the assurance of the adhesion to the first common electrode 71 located at the lower layer of the second thin film piezoelectric body 74 and the suppression of the damage to the second thin film piezoelectric body 74.

In addition, in the non-overlapping region S2, the second thin film piezoelectric body 74 has a portion laminated on the first common electrode 71. In the present embodiment, the second thin film piezoelectric body 74 is in direct contact with the first common electrode 71. Since the second thin film piezoelectric body 74 is laminated on the first common electrode 71, the effect of suppressing the peeling-off of the second thin film piezoelectric body 74 from the first common electrode 71 can be remarkably exhibited in the above-described configuration in which the upper portion of the second thin film piezoelectric body 74y is not present. In particular, when the second thin film piezoelectric body 74 is in direct contact with the first common electrode 71, the effect of suppressing the peeling-off is effectively exhibited. Even when a member having a thickness of approximately 1/10 of the first common electrode 71 is provided between the second thin film piezoelectric body 74 and the first common electrode 71, the effect of suppressing the peeling-off can be remarkably exhibited.

In addition, the width of the non-overlapping region S2 is 25% or more and 43% or less of the width of the overlapping region S1. The width is the length in the X1 direction that is the extending direction. In addition, in the present embodiment, one piezoelectric element 7 has one overlapping region S1 and two non-overlapping regions S2 between which the overlapping region S1 is interposed. Therefore, the width of the non-overlapping region S2 and the total width of the two non-overlapping regions S2 are illustrated.

The non-overlapping region S2 is the inactive portion of the piezoelectric elements 7. Therefore, when the width of the non-overlapping region S2 is 25% or more and 43% or less of the width of the overlapping region S1, it is possible to remarkably achieve both the assurance of the adhesion to the first common electrode 71 located at the lower layer of the second thin film piezoelectric body 74 and the suppression of the damage to the second thin film piezoelectric body 74 as compared with when the range is not satisfied.

As illustrated in FIG. 4, a third position P3, which is a position of a portion of the upper surface 720 of the first thin film piezoelectric body 72 that overlaps the individual electrodes 73 when viewed in the Z1 direction, is located lower than the first position P1. The third position P3 is a portion of the upper surface 720 of the first thin film piezoelectric body 72 in the overlapping region S1, which is parallel to the X-Y plane. Further, in the present embodiment, the third position P3 is located lower than the second position P2. Since the third position P3 is located lower than the first position P1, it is possible to particularly effectively suppress the possibility that the above-described damage occurs in the second thin film piezoelectric body 74. In the present embodiment, the third position P3 is located lower than the second position P2. Therefore, it is possible to further effectively suppress the possibility that the above-described damage occurs in the second thin film piezoelectric body 74.

The third position P3 may be the same as the second position P2 or may be located higher than the second position P2.

### 1-5. Manufacturing Method of Piezoelectric Elements 7

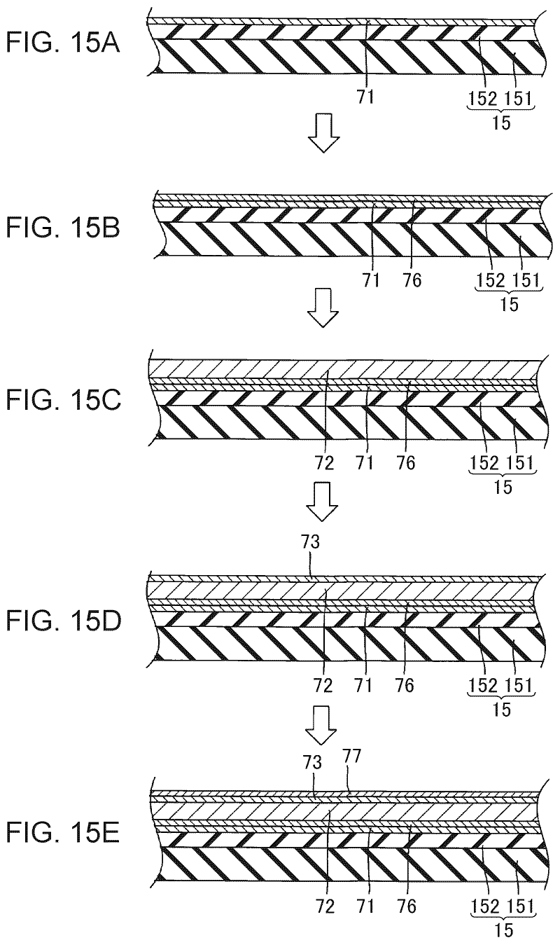

Each of FIGS. 15A to 15E, 16A to 16D, and 17A to 17C is a diagram illustrating a manufacturing method of the piezoelectric elements 7 illustrated in FIG. 4. As illustrated in FIG. 15A, the first common electrode 71 is formed on the diaphragm 15. The first common electrode 71 is formed by using, for example, a known film forming technique such as a vapor deposition method or a sputtering method, and a known processing technique using photolithography, etching, or the like.

Then, as illustrated in FIG. 15B, the first orientation control layer 76 is formed on the first common electrode 71. The first orientation control layer 76 is formed by using, for example, a known film forming technique such as a vapor deposition method or a sputtering method.

Then, as illustrated in FIG. 15C, the first thin film piezoelectric body 72 is formed on the first orientation control layer 76. The first thin film piezoelectric body 72 is formed by, for example, forming a precursor layer of the first thin film piezoelectric body 72 by a sol-gel method and crystallizing the precursor layer by firing. In addition, the first thin film piezoelectric body 72 may be formed by using a sputtering method. However, when the sol-gel method is used, the first thin film piezoelectric body 72 having a thickness of 2 μm or less, and more preferably 1 μm or less can be suitably formed.

Then, as illustrated in FIG. 15D, the individual electrode 73 is formed on the first thin film piezoelectric body 72. As illustrated in FIG. 15D, for example, the individual electrode 73 is formed by patterning a film, which is formed by using a known film forming technique such as a vapor deposition method or a sputtering method, by etching

Then, as illustrated in FIG. 15E, the second orientation control layer 77 is formed on the individual electrode 73. The second orientation control layer 77 is formed by using, for example, a known film forming technique such as a vapor deposition method or a sputtering method.

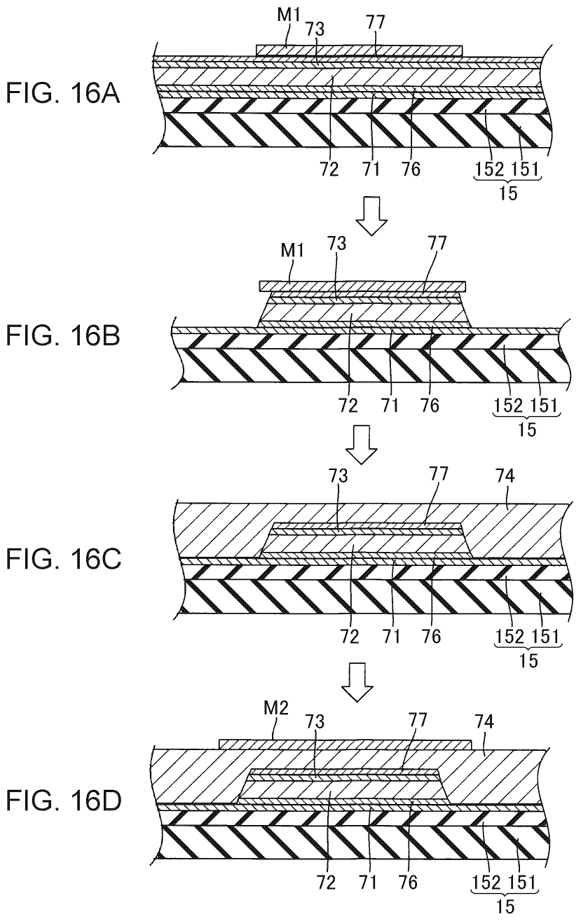

Then, as illustrated in FIG. 16A, a resist mask M1 formed by, for example, photolithography is formed on the second orientation control layer 77. Then, as illustrated in FIG. 16B, the second orientation control layer 77, the individual electrode 73, the first thin film piezoelectric body 72, and the first orientation control layer 76 are patterned by etching using the resist mask M1. Then, the resist mask M1 is removed.

Then, as illustrated in FIG. 16C, the second thin film piezoelectric body 74 is formed on the second orientation control layer 77 and the first common electrode 71. The second thin film piezoelectric body 74 is formed by, for example, forming a precursor layer of the second thin film piezoelectric body 74 by a sol-gel method and crystallizing the precursor layer by firing. In addition, the second thin film piezoelectric body 74 may be formed by using a sputtering method. However, when the sol-gel method is used, the second thin film piezoelectric body 74 having a thickness of 2 μm or less, and more preferably 1 μm or less, can be suitably formed.

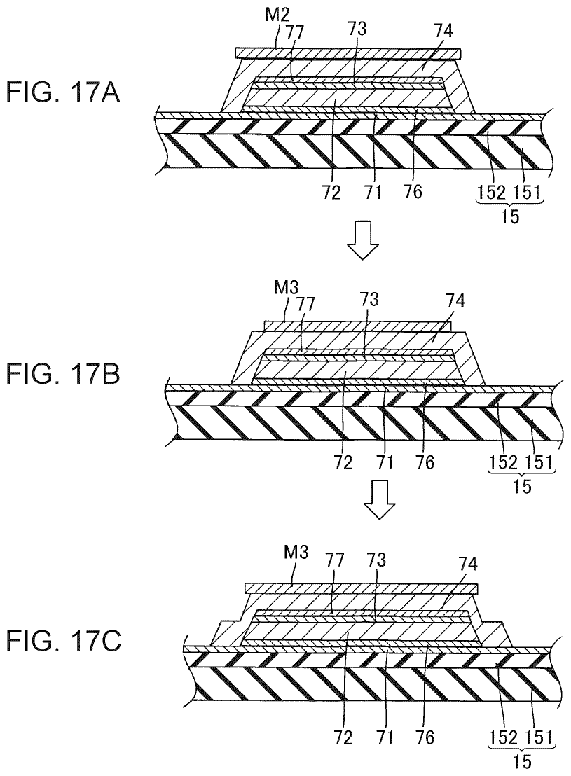

Then, as illustrated in FIG. 16D, a resist mask M2 formed by, for example, photolithography is formed on the second thin film piezoelectric body 74. Then, as illustrated in FIG. 17A, the second thin film piezoelectric body 74 is patterned by etching using the resist mask M2.

Then, as illustrated in FIG. 17B, the resist mask M2 is peeled off to form the resist mask M3 having a smaller plane area than the resist mask M2. The resist mask M2 may be processed to form the resist mask M3 having a smaller plane area than the resist mask M2. Then, as illustrated in FIG. 17C, a portion of the second thin film piezoelectric body 74 is patterned. As a result, the second thin film piezoelectric body 74 having a first portion and a second portion is formed. Then, the resist mask M3 is removed, and the second common electrode 75 is formed.

The piezoelectric elements 7 of the liquid ejecting head 1 is manufactured by the above-described method. With such a method, the piezoelectric elements 7 can be manufactured easily and with high accuracy. In addition, with such a method, the piezoelectric elements 7 having the overlapping region S1 in which the second thin film piezoelectric body 74 overlaps the individual electrode 73 when viewed in the Z1 direction and the non-overlapping region S2 in which the second thin film piezoelectric body 74 does not overlap the individual electrodes 73 when viewed in the Z1 direction can be easily and reliably formed. With such a method, the above-described piezoelectric elements 7 including the upper surface 740 having the first upper surface portion 7401 at the first position P1 and the second upper surface portion 7402 at the second position P2 located lower than the first upper surface portion 7401 can be manufactured.

The manufacturing method of the piezoelectric elements 7 is not limited to the above-described method. For example, after manufacturing the lower portion of the second thin film piezoelectric body 74, the remaining portion of the second thin film piezoelectric body 74 may be manufactured.

### 2. MODIFICATION EXAMPLE

The embodiments described above may be modified in various ways. A specific modification aspect that can be applied to the embodiments described above will be described below.

### 2-1. Modification Example

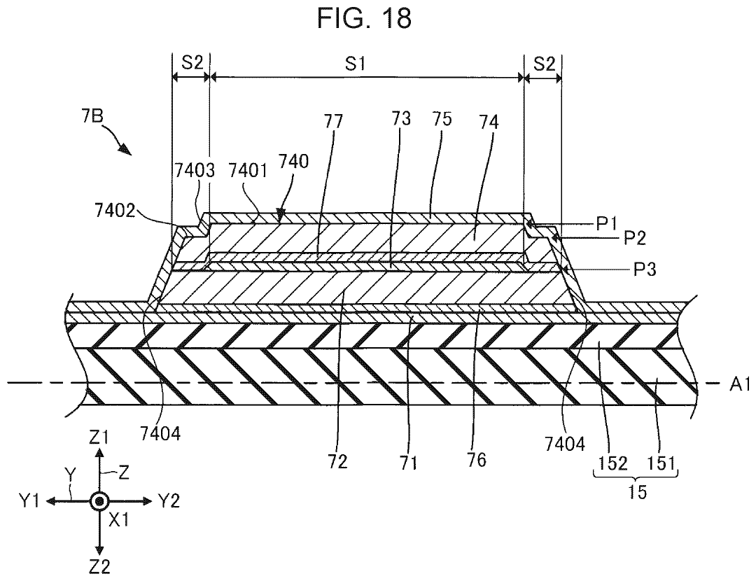

FIG. 18 is a cross-sectional view of a piezoelectric element 7B of a modification example. In the example illustrated in FIG. 18, an upper surface of the second thin film piezoelectric body 74 has a step. Therefore, an upper surface of the second common electrode 75 also has a step following the upper surface of the second thin film piezoelectric body 74.

The second position P2 of the second upper surface portion 7402 of the second thin film piezoelectric body 74 in the non-overlapping region S2 is located lower than the first position P1 of the first upper surface portion 7401 of the second thin film piezoelectric body 74 in the overlapping region S1.

Even with the piezoelectric element 7B of such a modification example, it is possible to achieve both the assurance of the adhesion to the first common electrode 71 located at the lower layer of the second thin film piezoelectric body 74 and the suppression of the damage to the second thin film piezoelectric body 74. Therefore, the reliability of the piezoelectric element 7B can be improved, and thus the reliability of the liquid ejecting head 1 can be improved.

In addition, in the non-overlapping region S2, the first thin film piezoelectric body 72 is laminated on the first common electrode 71. In the present embodiment, the first thin film piezoelectric body 72 is in direct contact with the first common electrode 71. In addition, in the non-overlapping region S2, the second thin film piezoelectric body 74 is laminated on the first thin film piezoelectric body 72. In the present embodiment, the second thin film piezoelectric body 74 is not in direct contact with the first common electrode 71. Therefore, it is possible to avoid peeling-off of the second thin film piezoelectric body 74 from the first common electrode 71.

In the present embodiment, the second orientation control layer 77 is present between the first thin film piezoelectric body 72 and the second thin film piezoelectric body 74, but the second orientation control layer 77 need not be interposed therebetween.

### 2-2. Other Modification Examples

The “liquid ejecting head” may be a circulation type head having a so-called circulation flow path.

The “liquid ejecting apparatus” can be adopted in various apparatuses, such as a facsimile machine and a copying machine, in addition to an apparatus dedicated to printing. Use of the liquid ejecting apparatus is not limited to printing. For example, a liquid ejecting apparatus that ejects a solution of a coloring material is used as a manufacturing apparatus that forms a color filter of a display device, such as a liquid crystal display panel. In addition, a liquid ejecting apparatus that ejects a solution of a conductive material is used as a manufacturing apparatus that forms a wiring line or an electrode of a wiring substrate. In addition, a liquid ejecting apparatus that ejects a solution of an organic substance related to an organism is used as a manufacturing apparatus that manufactures a biochip, for example.

Although the present disclosure is described above based on the preferred embodiments, the present disclosure is not limited to the above-described embodiments. The configuration of each section of the present disclosure can be replaced with any configuration having the same function in the above-described embodiments, and any configuration can be added.

What is claimed is:

1. A liquid ejecting head comprising:
a pressure chamber substrate in which a plurality of pressure chambers are arranged in an arrangement direction;
a diaphragm;
a first common electrode that is provided to be shared by the plurality of pressure chambers and to which a reference voltage that does not change over time is applied;
a first thin film piezoelectric body;
an individual electrode that is individually provided for each of the plurality of pressure chambers so as to extend in an extending direction intersecting the arrangement direction and to which a driving voltage that changes over time is applied;
a second thin film piezoelectric body; and
a second common electrode that is provided to be shared by the plurality of pressure chambers and to which the reference voltage is applied,
the pressure chamber substrate, the diaphragm, the first common electrode, the first thin film piezoelectric body, the individual electrode, the second thin film piezoelectric body, and the second common electrode being laminated in a stated order from a lower side to an upper side in a lamination direction intersecting the arrangement direction and the extending direction, wherein
when a region in the arrangement direction where the second thin film piezoelectric body overlaps all of the individual electrode, the first common electrode, and the second common electrode when viewed in the lamination direction is defined as an overlapping region, and a region in the arrangement direction where the second thin film piezoelectric body overlaps the first common electrode and the second common electrode and does not overlap the individual electrode when viewed in the lamination direction is defined as a non-overlapping region,
a position of an upper surface of the second thin film piezoelectric body in the overlapping region is a first position, and
the position of the upper surface of the second thin film piezoelectric body in the non-overlapping region is a second position that is located lower than the first position.

2. The liquid ejecting head according to claim 1, wherein
at a boundary between the overlapping region and the non-overlapping region, the position of the upper surface of the second thin film piezoelectric body is gradually lowered from the first position to the second position.

3. The liquid ejecting head according to claim 1, wherein
at a portion, in the non-overlapping region, that is located farther from the individual electrode in the arrangement direction than a portion at which the position of the upper surface of the second thin film piezoelectric body is the second position, the position of the upper surface of the second thin film piezoelectric body is gradually lowered from the second position.

4. The liquid ejecting head according to claim 1, wherein
in the non-overlapping region, the second thin film piezoelectric body is laminated on the first common electrode.

5. The liquid ejecting head according to claim 1, wherein
in the non-overlapping region, the first thin film piezoelectric body is laminated on the first common electrode, and
in the non-overlapping region, the second thin film piezoelectric body is laminated on the first thin film piezoelectric body.

6. The liquid ejecting head according to claim 1, wherein
a position of an upper surface of the first thin film piezoelectric body in the overlapping region is a third position that is located lower than the first position.

7. The liquid ejecting head according to claim 1, wherein
a width of the non-overlapping region is 25% or more and 43% or less of a width of the overlapping region.

8. The liquid ejecting head according to claim 1, wherein
the overlapping region has a portion in which the position of the upper surface of the second thin film piezoelectric body is constant at the first position, and
the non-overlapping region has a portion in which the position of the upper surface of the second thin film piezoelectric body is constant at the second position.

9. The liquid ejecting head according to claim 1, wherein
the overlapping region and the non-overlapping region are located at the same position in the extending direction and at positions adjacent to each other in the arrangement direction.

10. A liquid ejecting apparatus comprising:
the liquid ejecting head according to claim 1; and
a voltage application circuit for applying the reference voltage and the driving voltage.
